(19) United States
(12) Patent Application Publication
(10) Pub. No.: US 2011/0300307 A1
(43) Pub. Date: Dec. 8, 2011

(54) METHOD FOR MANUFACTURING WIRING BOARD

(75) Inventors: Toru NAKAI, Ogaki-shi (JP); Tetsuo Amano, Ogaki-shi (JP); Atsushi Kamano, Ogaki-shi (JP); Yoshinori Takasaki, Ogaki-shi (JP)

(73) Assignee: IBIDEN CO., LTD., Ogaki-shi (JP)

(21) Appl. No.: 13/150,744

(22) Filed: Jun. 1, 2011

Related U.S. Application Data
(60) Provisional application No. 61/351,557, filed on Jun. 4, 2010.

(51) Int. Cl. B05D 5/12; B05D 3/06

(52) U.S. Cl. 427/555; 427/554

(57) ABSTRACT

A method for manufacturing a wiring board includes forming a conductive pattern on an insulation layer, forming on the conductive pattern a resin insulation layer containing a resin and a silica-type filler, and irradiating a laser beam having an absorption rate with respect to the conductive pattern is in an approximate range of 30˜60% such that an opening portion reaching the conductive pattern is formed through the resin insulation layer. The silica-type filler in the resin insulation layer is in an amount of approximately 2˜60 wt. %.

### CROSS-REFERENCE TO RELATED APPLICATIONS

The present application claims the benefits of priority to U.S. Application No. 61/351,557, filed Jun. 4, 2010. The contents of that application are incorporated herein by reference in their entirety.

### BACKGROUND OF THE INVENTION

1. Field of the Invention

The present invention relates to a method for manufacturing a wiring board, especially to a technique for exposing a conductive pattern from an insulation layer.

2. Discussion of the Background

Japanese Laid-Open Patent Publication H10-308576 describes a method for manufacturing a wiring board, in which openings are formed in solder resist by irradiating a CO₂ laser on the solder resist (insulation layer) and pads are exposed through the opening portions. In the present application, the contents of Japanese Laid-Open Patent Publication H10-308576 are incorporated herein by reference in their entirety.

### SUMMARY OF THE INVENTION

According to one aspect of the present invention, a method for manufacturing a wiring board includes forming a conductive pattern on an insulation layer, forming on the conductive pattern a resin insulation layer containing a resin and a silica-type filler, and irradiating a laser beam having an absorption rate with respect to the conductive pattern is in an approximate range of 30˜60% such that an opening portion reaching the conductive pattern is formed through the resin insulation layer. The silica-type filler in the resin insulation layer is in an amount of approximately 2˜60 wt. %.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a cross-sectional view of a wiring board according to an embodiment of the present invention;

FIG. 2 is a plan view of a wiring board according to the embodiment of the present invention;

FIG. 3 is a view showing an example in which electronic components are mounted on surfaces of a wiring board manufactured according to the embodiment of the present invention;

FIG. 4 is a magnified view showing part of the view in FIG. 1;

FIG. 5 is a magnified view showing part of the view in FIG. 4;

FIG. 6 is a magnified view showing part of the surface of a conductive layer exposed from solder resist;

FIG. 7 is a flowchart showing a method for manufacturing a wiring board according to the embodiment of the present invention;

FIG. 8A is a view to illustrate a first step for forming a conductive layer on an insulation layer;

FIG. 8B is a view to illustrate a second step for forming a conductive layer on an insulation layer;

FIG. 8C is a view to illustrate a third step for forming a conductive layer on an insulation layer;

FIG. 9 is a view showing a conductive layer (pad) formed in the steps shown in FIGS. 8A˜8C;

FIG. 10 is a view to illustrate a step for forming solder resist on an insulation layer to cover a pad (conductive pattern);

FIG. 11 is a plan view to illustrate a step for irradiating a laser;

FIG. 12 is a cross-sectional view to illustrate a step for irradiating a laser;

FIG. 13 is a view to illustrate an example of conditions when moving a laser (more specifically, its aiming point);

FIG. 14 is a graph showing relationships between laser wavelengths and absorption rates in each material;

FIG. 15 is a table showing the results when hole boring and desmearing are performed in solder resist by irradiating five laser beams having different wavelengths;

FIG. 16 is a cross-sectional view showing an example of a wiring board in which a pad (conductive pattern) is triple-layered with metal foil, electroless plated film and electrolytic plated film;

FIG. 17 is a view showing an example in which the filler contained in solder resist (insulation layer) is formed primarily with spherical silica;

FIG. 18 is a view showing an example in which the manufacturing method of the above embodiment is employed to form an inner-layer portion of a wiring board;

FIG. 19 is a view showing an example in which the manufacturing method of the above embodiment is employed to manufacture a wiring board with a built-in electronic component;

FIG. 20 is a view showing an example in which the manufacturing method of the above embodiment is employed to manufacture a flex-rigid wiring board; and

FIG. 21 is a view showing an example in which the manufacturing method of the above embodiment is employed to manufacture a wiring board with another built-in wiring board.

### DETAILED DESCRIPTION OF THE EMBODIMENTS

The embodiments will now be described with reference to the accompanying drawings, wherein like reference numerals designate corresponding or identical elements throughout the various drawings.

In the drawings, arrows (Z1, Z2) each indicate a lamination direction in a wiring board, corresponding to a direction along a normal line (or a direction of the thickness of a core substrate) to the main surfaces (upper and lower surfaces) of the wiring board. On the other hand, arrows (X1, X2) and (Y1, Y2) each indicate a direction perpendicular to a lamination direction (directions parallel to the main surfaces of the wiring board). The main surfaces of a wiring board are on the X-Y plane. Side surfaces of a wiring board are on the X-Z plane or the Y-Z plane.

In the present embodiment, two main surfaces facing opposite directions of a normal line are referred to as a first surface (the Z1-side surface) and a second surface (the Z2-side surface). Namely, a main surface opposite the first surface is the second surface, and a main surface opposite the second surface is the first surface. In lamination directions, the side closer to the core is referred to as a lower layer (or inner-layer side), and the side farther away from the core is referred to as an upper layer (or outer-layer side).

Conductive layers indicate layers including conductive patterns. Conductive patterns of conductive layers may be determined freely and may include wiring (including ground), pads, lands and so forth that form conductive circuits. Also, conductive patterns may be those such as plain patterns that do not form conductive circuits. In addition, in a wiring board with a built-in electronic component or another wiring board, electrodes of the electronic component and pads of the other wiring board are included in conductive patterns. Pads include external connection terminals, via connection terminals, electrodes of an electronic component, etc. Insulation layers include interlayer insulation layers and solder resist. Opening portions include holes, grooves, notches, slits and so forth. Holes include via holes and through holes. Among the conductors formed in holes, conductive film formed on internal surfaces of a hole (side and bottom surfaces) is referred to as a conformal conductor, and conductor filled in a hole is referred to as a filled conductor.

Plating indicates depositing a layer of conductor (such as metal) on surfaces of metal, resin or the like as well as the deposited conductive layer (such as a metal layer). Plating includes wet plating such as electrolytic plating and electroless plating as well as dry plating such as PVD (physical vapor deposition) and CVD (chemical vapor deposition).

Laser beam is not limited to visible light. In addition to visible light, laser beam includes electromagnetic waves with a short wavelength such as ultraviolet rays and X-rays as well as electromagnetic waves with a long wavelength such as infrared light. The absorption rate of laser beam in each material is the value measured by a spectrophotometer.

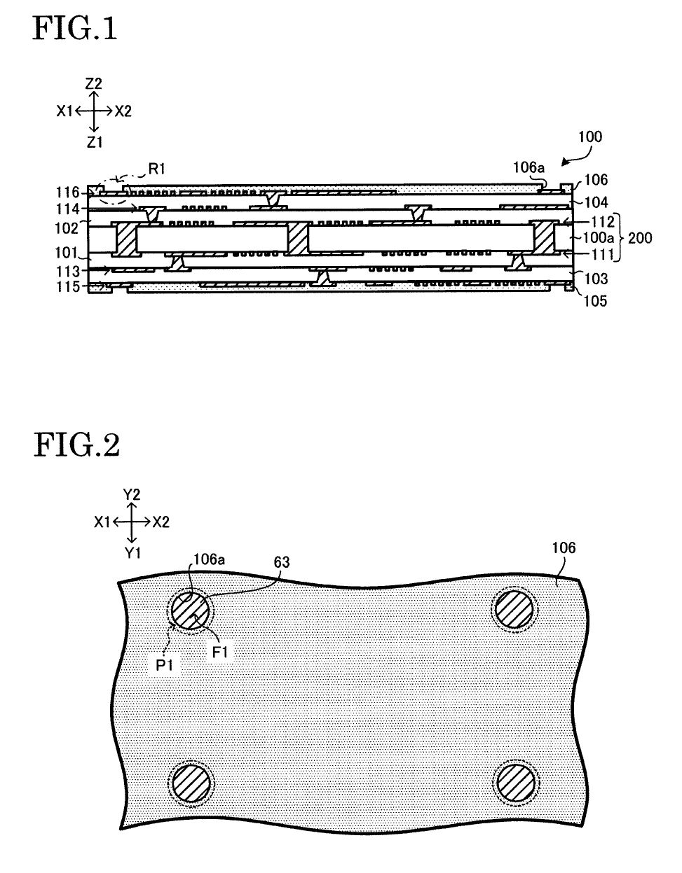

Wiring board 100 of the present embodiment is a multilayer printed wiring board (double-sided rigid wiring board), for example, as shown in FIG. 1 (cross-sectional view) and FIG. 2 (plan view). Wiring board 100 has substrate 200 (core substrate), insulation layers (101˜104) (interlayer insulation layers), solder resists (105, 106) (insulation layers) and conductive layers (113˜116). Here, on the first-surface side of substrate 200, two insulation layers (101, 103) and two conductive layers (113, 115) are alternately laminated. Also, on the second-surface side of substrate 200, two insulation layers (102, 104) and two conductive layers (114, 116) are alternately laminated. Then, solder resist 105 is formed on the first-surface side outermost layer, and solder resist 106 is formed on the second-surface side outermost layer. In the present embodiment, conductive layers (113˜116) each include conductive circuits formed with wiring, pads (terminals) and the like. However, conductive patterns of conductive layers (113˜116) may be determined freely, and it is not always required that circuits be formed in each layer. Also, in the present embodiment, insulation layers (101˜104) and solder resists (105, 106) correspond to resin insulation layers.

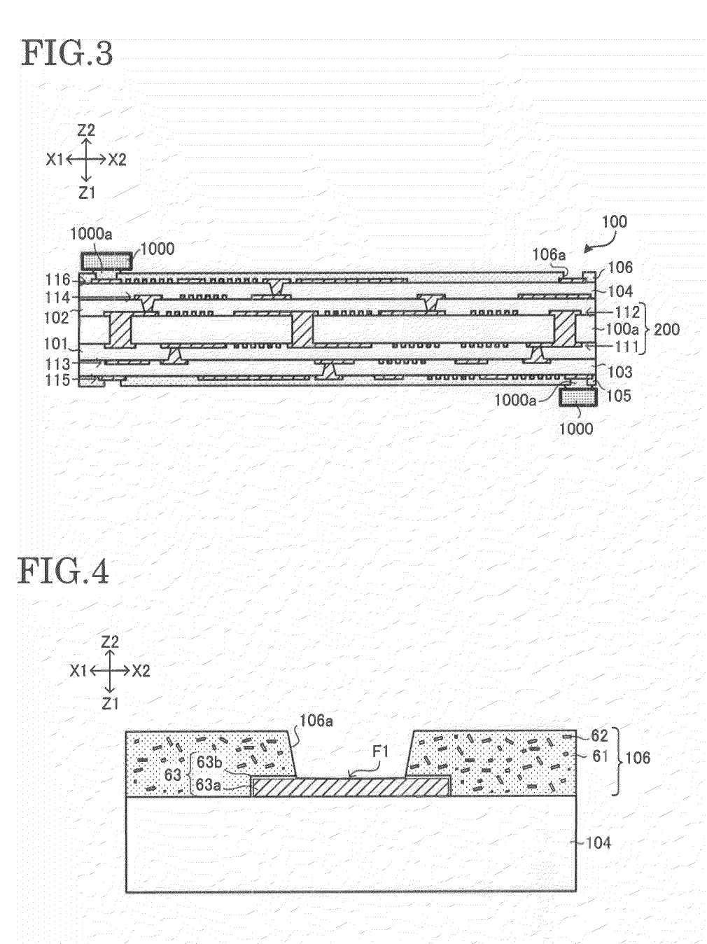

As shown in FIG. 3, electronic component 1000 (or another wiring board or the like) is mounted on a surface (either surface or both surfaces) of wiring board 100 through solder (1000a), for example. Wiring board 100 may be used as a circuit substrate for a cell phone or the like, for example.

Wiring board 100 may be a rigid wiring board or a flexible wiring board. Also, wiring board 100 may be a double-sided wiring board or a single-sided wiring board. The number of layers of conductive layers and insulation layers may be determined freely.

Substrate 200 has insulation layer (100a) and conductive layers (111, 112). As for substrate 200, a double-sided copper-clad laminate may be used, for example. Also, substrate 200 may be manufactured by using a double-sided copper-clad laminate or an insulative sheet as a starting material and then by performing plating or the like.

FIG. 4 shows a magnified view of region (R1) in FIG. 1.

Pad 63 is part of conductive layer 116 (a conductive pattern, specifically), and functions as an external connection terminal. When solder (1000a) (FIG. 3) is formed on pad 63, protective conductive film such as Ni/Au, for example, may be formed on the surface of pad 63.

Pad 63 is formed with conductor (63a) and oxidized film (63b). Oxidized film (63b) is formed on a surface of conductor (63a) and coats conductor (63a). However, opening portion (106a) (such as a hole) is formed in solder resist 106 and oxidized film (63b) is removed from opening portion (106a). Accordingly, conductor (63a) (surface (F1) of pad 63) is exposed through opening portion (106a). Thus, when solder (1000a) (FIG. 3) is formed on pad 63, an increase in resistance does not result from oxidized film (63b). It is not always required to form oxidized film (63b) on the surface of conductor (63a).

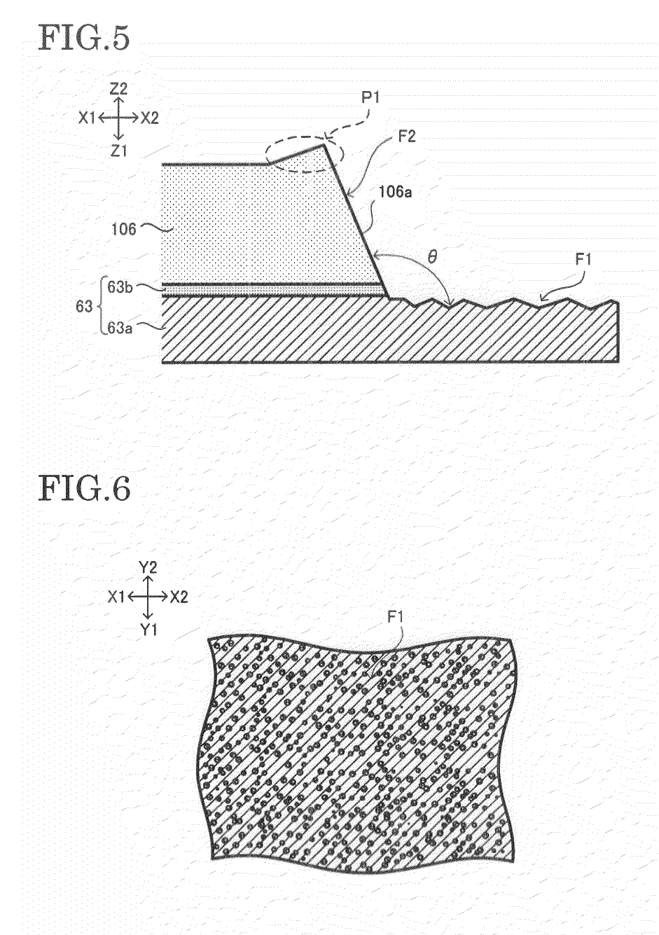

Here, surface (F1) (the surface of exposed conductive layer 116) is roughened as shown in FIG. 5 and FIG. 6 (partially magnified view of surface (F1)). Accordingly, bonding strength increases between surface (F1) of pad 63 and solder (1000a) (FIG. 3) or the like. The 10-point mean roughness on surface (F1) is preferred to be in an approximate range of 0.5˜1 μm.

Moreover, as shown in FIG. 2 and FIG. 5, protruding portion (P1) is formed on the periphery of opening portion (106a). Also, in FIG. 5, angle (θ) is set, for example, at approximately 90 degrees or greater between surface (F1) exposed through opening portion (106a) and side surface (F2) on the side of opening portion (106a) in solder resist 106.

Solder resist 106 (insulation layer) is made by adding approximately 2˜60 wt. % filler 62 to resin 61. Resin 61 has insulative and thermosetting features. Filler 62 is made of a silica-type filler. If the percentage of the contained amount is in the above range, opening portion (106a) is formed in solder resist 106 using a low laser intensity without damaging the surface of pad 63 (detailed description will be provided later). Also, the requirements of lower CTE (coefficient of thermal expansion) of solder resist 106 are satisfied in a printed wiring board.

As a silica-type filler, silicate minerals are preferred to be used. As for silicate minerals, they are preferred to contain at least one from among silica, talc, mica, kaolin and calcium silicate. Especially, they are preferred to contain at least one from among silica, a metal compound surface-treated with silica, and talc.

As a preferred example, solder resist 106 contains a silica-type filler made of approximately 10˜20 wt. % talc (3MgO.4SiO₂.H₂O) and approximately 10˜20 wt. % silica, namely, a total of approximately 20˜40 wt. % silica-type filler.

As for silica, at least one from among ground silica, spherical silica, fused silica and crystalline silica is preferred to be used. In the present embodiment, filler 62 (silica-type filler) contains amorphous ground silica (hereinafter referred to as ground silica). Since ground silica has a lower reflectance than spherical silica, by adjusting the amount of filler 62, it becomes easier to make fine adjustments between the effects of lowering laser absorption rates and the effects of enhancing efficiency in removing solder resist 106 as described later. Especially, 50% or more of filler 62 (silica-type filler) should preferably be ground silica. If the primary (half or greater) ingredient of filler 62 is ground silica, since filler 62 reflects laser, effects such as reduced damage to conductors or delay in damage progression (which will be described later in detail) increases. However, the amount of contained ground silica is not limited to the above, and it may be less than 50 wt. %. Alternatively, it is an option for filler 62 not to contain ground silica (see later-described FIG. 17).

The average particle diameter of filler 62 (silica-type filler) is preferred to be in an approximate range of 0.5˜20 μm. If the average particle diameter of filler 62 is in such a range, the effects of lowering laser absorption rates by filler 62 are considered to be greater (detailed description will be provided later).

In the present embodiment, resin 61 is made of thermosetting epoxy resin. However, resin 61 (thermosetting resin) is not limited to such and the following may be used instead of epoxy resin: phenol resin, polyphenylene ether (PPE), polyphenylene oxide (PPO), fluororesin, LCP (liquid crystal polymer), polyester resin, imide resin (polyimide), BT resin, allyl polyphenylene ether resin (A-PPE resin) or aramid resin. Alternatively, resin 61 may be made of UV curing resin instead of thermosetting resin. As for UV curing resin, epoxy acrylate resin, acrylic resin or the like may be listed, for example.

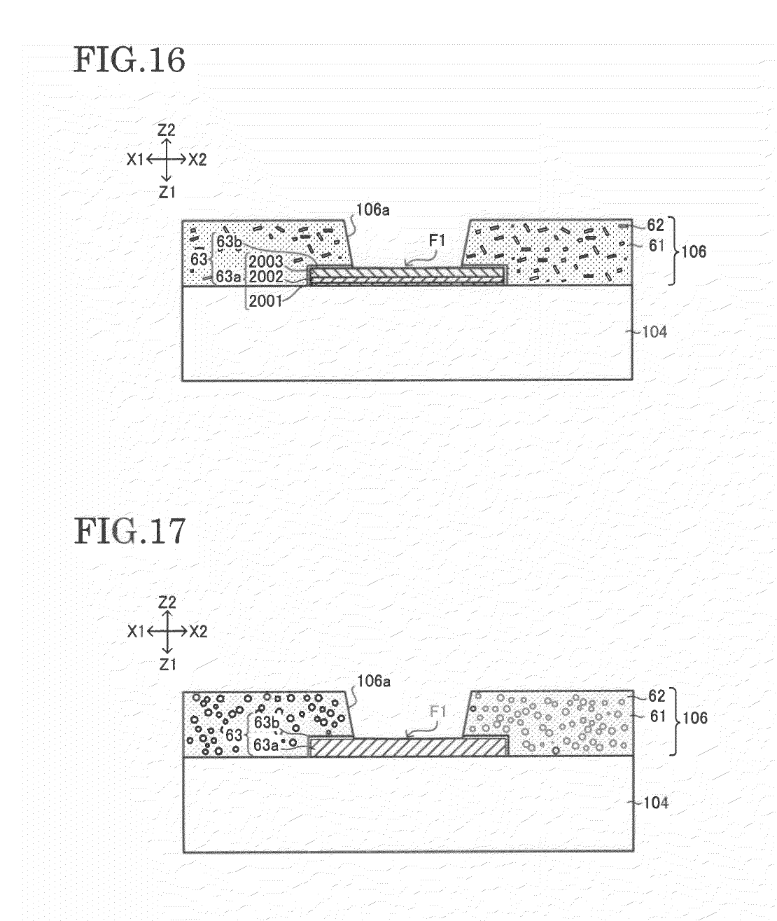

Conductive layers (113˜116) including pad 63 are double-layered with electroless plated film and electrolytic plated film, for example. However, they are not limited to such, and pad 63 or the like may be triple-layered with metal foil (such as copper foil), electroless plated film and electrolytic plated film, for example (see later-described FIG. 16).

In the present embodiment, electroless plated film and electrolytic plated film are made of copper, and when electroless plated film is formed, palladium is used as a catalyst. However, electroless plated film and electrolytic plated film are not limited to such, and they may be made of other material (metal other than copper). Also, each conductive layer may be formed with multiple layers using different materials. The type of catalyst may be determined freely. In addition, a catalyst is not required unless necessary.

In the present embodiment, insulation layer (100a) and insulation layers (101˜104) are made of thermosetting epoxy resin. However, insulation layer (100a) and insulation layers (101˜104) are not limited to such, and their material may be determined freely. The resin to form insulation layers (101˜104) is preferred to be thermosetting resin or thermoplastic resin. As for thermosetting resin, other than epoxy resin, for example, imide resin (polyimide), BT resin, allyl polyphenylene ether resin (A-PPE resin), aramid resin or the like may be used. Also, as for thermoplastic resin, for example, liquid crystal polymer (LCP), PEEK resin, PTFE resin (fluororesin) or the like may be used. Such materials are preferred to be selected from the viewpoints of insulation, dielectric properties, heat resistance, mechanical features and so forth. In addition, additives such as curing agents, stabilizers, filler or the like may be contained in the above resin. Also, each insulation layer may be formed with multiple layers made of different materials.

Wiring board 100 may be manufactured by alternately building up insulation layers (101˜104) and conductive layers (113˜116) on substrate 200, for example, and then by forming solder resists (105, 106) on outermost layers.

Insulation layers (101˜104) may be formed (laminated) by vacuum laminating resin film, for example. Conductive layers (113˜116) may be formed using one of the following methods or a method combining any two or more such methods: panel plating method, pattern plating method, full-additive method, semi-additive (SAP) method, subtractive method and tenting method. Solder resists (105, 106) may be manufactured by screen printing, roll coating, laminating or the like, for example.

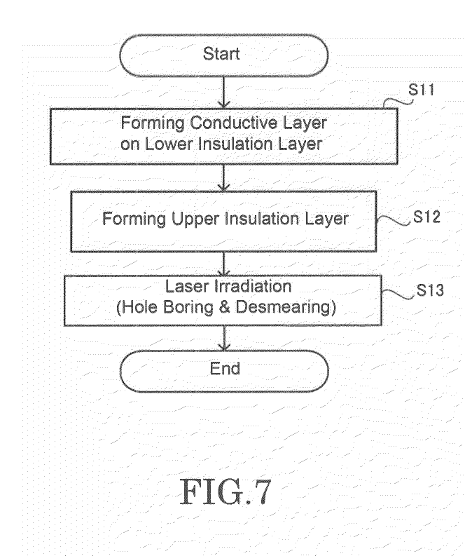

The above wiring board 100 (especially the structure shown in FIG. 4) is manufactured by the procedure shown in FIG. 7, for example.

A conductive layer is formed on an insulation layer (lower insulation layer) in step (S11).

In particular, insulation layer 104 (lower insulation layer) made of thermosetting epoxy resin, for example, is prepared, and the second surface of insulation layer 104 is roughened by etching, for example. A catalyst is adsorbed on the second surface (roughened surface) of insulation layer 104 by immersion, for example. The catalyst is palladium, for example. For immersion, a solution containing palladium chloride, palladium colloid or the like may be used. To immobilize the catalyst, heating may be conducted after immersion.

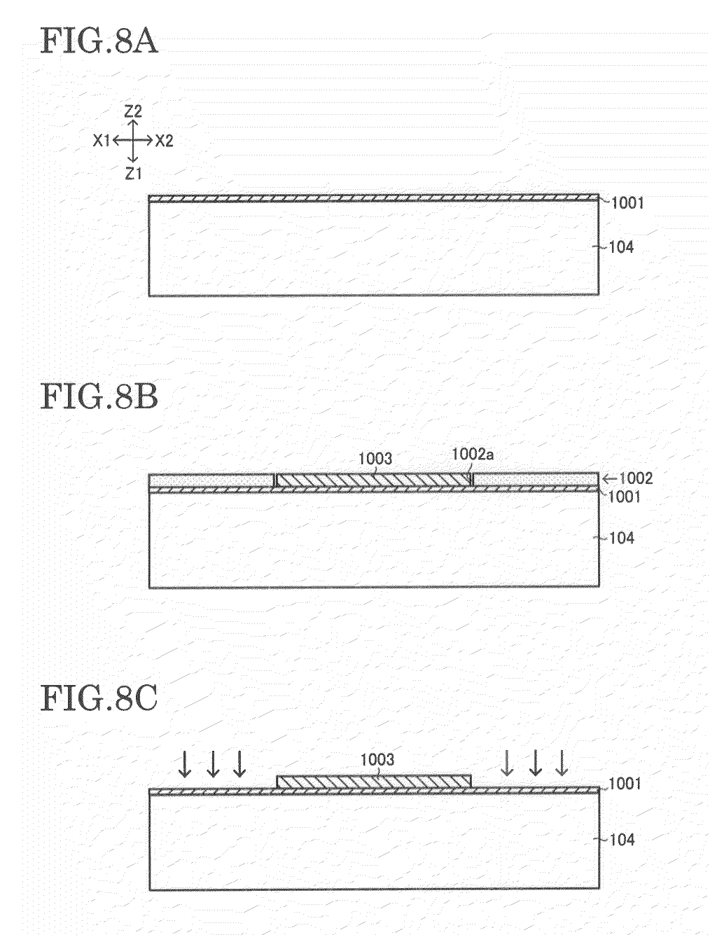

As shown in FIG. 8A, electroless plated film 1001, for example, is formed on the second surface of insulation layer 104 using a chemical plating method, for example. As for a plating solution, for example, a copper sulfate solution with an added reduction agent may be used. As for such a reduction agent, for example, formalin, hypophosphite, glyoxylic acid or the like may be used.

As shown in FIG. 8B, plating resist 1002 is formed on electroless plated film 1001. Plating resist 1002 has an opening portion (1002a) at a predetermined position. Using a pattern plating method, for example, electrolytic copper-plated film 1003, for example, is formed in opening portion (1002a) of plating resist 1002. In particular, the substrate is immersed in a plating solution and copper (high phosphorous copper), which is the plating material, is connected to the anode, and electroless plated film 1001, which is the material to be plated, is connected to the cathode. Then, electric current is passed by applying DC voltage between both electrodes so that the copper is deposited onto the second surface of exposed electroless plated film 1001 on the cathode side. Accordingly, electrolytic plated film 1003 is formed on a portion of electroless plated film 1001. As for a plating solution, a copper sulfate solution, copper pyrophosphate solution, copper cyanide solution, copper fluoroborate solution or the like may be used.

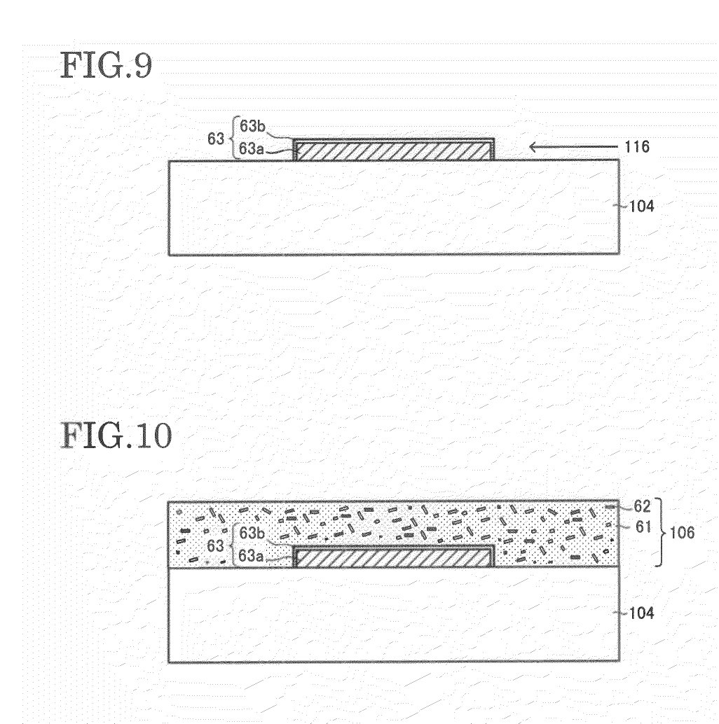

As shown in FIG. 8C, using a predetermined removal solution, for example, plating resist 1002 is removed. Using a laser or through etching, for example, unnecessary electroless plated film 1001 is removed. Accordingly, conductor (63a) is formed and oxidized film (63b) is formed on the surface of conductor (63a) as shown in FIG. 9. As a result, pad 63 is formed in conductive layer 116. The structure of conductor (63a) of pad 63 is not limited to a double-layer structure of electroless plated film and electrolytic plated film, and any other structure may be employed (see later-described FIG. 16).

In step (12) in FIG. 7, solder resist (upper insulation layer) is formed on insulation layer 104 (lower insulation layer) to coat pad 63 (conductive pattern).

In particular, as shown in FIG. 10, solder resist 106 (upper insulation layer) is formed on insulation layer 104 by, for example, screen printing, roll coating, lamination or the like. Accordingly, pad 63 is coated with solder resist 106. As described previously, solder resist 106 is formed by adding approximately 2˜60 wt. % filler 62 made of a silica-type filler to resin 61 made of thermosetting epoxy resin, for example. At this stage, solder resist 106 is semi-cured. In addition, the color of solder resist 106 is preferred to be greenish, blackish or bluish, considering its compatibility with a later-described green laser.

In step (S13) in FIG. 7, by irradiating laser beam, solder resist 106 on pad 63 (conductive pattern) is removed to expose pad 63 in that portion.

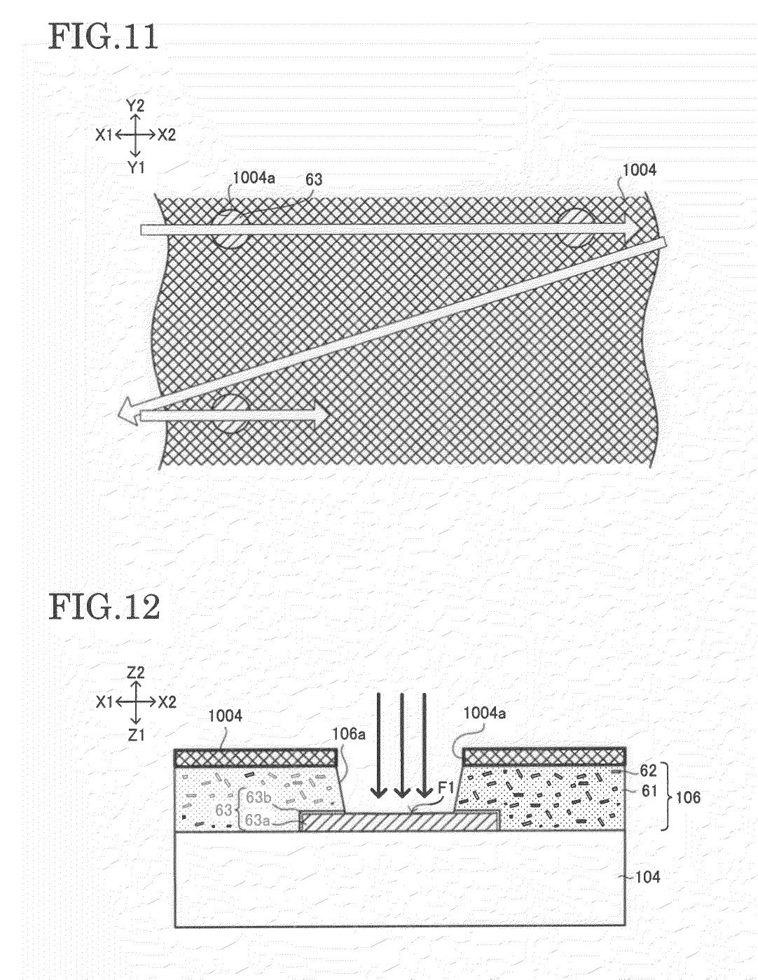

In particular, as shown in FIG. 11 and FIG. 12, for example, shading mask 1004 with opening portion (1004a) is placed on the second-surface side of an irradiation object (solder resist 106, etc.) and a green laser is irradiated on the entire surface (the entire second surface, in particular) of the object. Here, a green laser indicates a second harmonic of the fundamental wave with an approximate wavelength of 1,064 nm, namely, laser beam with an approximate wavelength of 532 nm.

Irradiation of such laser beam is carried out when solder resist 106 is semi-cured.

When the above green laser is irradiated on the entire surface of the object, it is preferred, for example, that the object be fixed and a green laser (more precisely, its aiming point) be moved, or alternatively, a green laser (more precisely, its aiming point) be fixed and the object be moved. When moving a green laser, it is preferred to move (scan) a green laser using a galvanometer mirror, for example. Alternatively, when moving the object, it is preferred that a green laser be made into linear beam using a cylindrical lens, for example, and that the object be moved using a conveyor while irradiating such beam on a predetermined spot.

Laser intensity (amount of beam) is preferred to be adjusted by pulse control. In particular, for example, when laser intensity is changed, the laser intensity per shot (one irradiation) is not changed, but the number of shots (irradiation number) is changed. Namely, if the required laser intensity is not achieved by one shot, laser beam is irradiated again on the same irradiation spot. Using such a control method, throughput improves since time to change irradiation conditions is omitted.

However, the method for adjusting laser intensity is not limited to the above, and any other method may be taken. For example, irradiation conditions may be determined for each irradiation spot and the number of irradiations may be set constant (for example, one shot per one irradiation spot). Alternatively, when a laser is irradiated multiple times at the same irradiation spot, laser intensity may be changed for each shot.

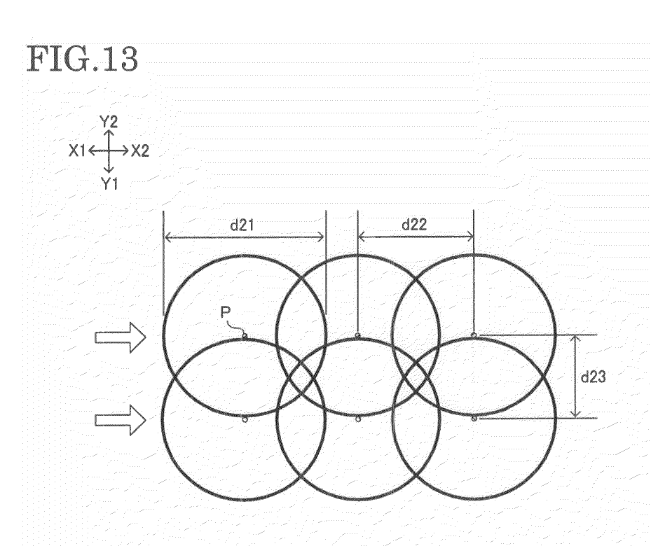

Here, an example of conditions is shown for moving a green laser using a galvanometer mirror. In FIG. 13, spot diameter (d21) of the laser beam is set at 30 μm, for example. In that example, the scanning direction of the laser beam is set in a direction X. Unit moving amount (d22) (distance between irradiation centers (P) of adjacent spots) in a direction X is set at 20 μm, for example. Also, unit moving amount (d23) (distance between irradiation centers (P) of adjacent spots) in a direction Y is set at 15 μm, for example. The scanning speed of laser beam is set at 3,000 mm/sec., for example. Namely, when laser beam is scanned 20 μm per shot in a direction X, laser beam is irradiated at 150,000 shots per second.

In the following, an example of laser irradiation is described by taking an example to perform laser irradiation under the above conditions.

A laser is irradiated at a first line, for example, (0, 0) through (XX, 0), on the X-Y plane of an irradiation object. More specifically, a laser is irradiated on the first irradiation spot (0, 0), and when the irradiation is finished, the laser is moved toward X2 by unit moving amount (d22), and then the laser is irradiated on the next irradiation spot (20, 0). Then, as shown by arrows in FIG. 11, irradiating a laser and moving toward X2 are repeated so that each predetermined irradiation spot in a direction X of the object is irradiated one by one. Accordingly, when irradiating a green laser is finished in the entire direction X of the object, laser irradiation on the first line is completed.

A laser is irradiated at the second line, for example, (0, 15) through (XX, 15), on the X-Y plane of the object. More specifically, as shown by arrows in FIG. 11, the green laser moves its X coordinate from the last irradiation spot (XX, 0) of the first line to the original point, while moving its Y coordinate toward the Y1 side by unit moving amount (d23), and resumes scanning laser beam from irradiation spot (0, 15) toward the X2 side the same as in the first line. As described, by irradiating a laser one by one at each line, the entire second surface (X-Y plane) of the object may be irradiated by a green laser.

Here, an example is shown in which laser beam is scanned along a direction X. However, laser beam may be scanned along a direction Y. Also, without using shading mask 1004, it is an option to irradiate laser beam at portions required to be irradiated, while halting laser irradiation at portions not required to be irradiated. Other than those, irradiation spots, a method for adjusting laser intensity and so forth may be determined freely.

In step (S13) in FIG. 7, laser beam is irradiated by scanning once per one irradiation object. Accordingly, wiring board 100 is manufactured at higher production efficiency. However, the method for manufacturing wiring board 100 is not limited to such a scanning method, and a laser may be scanned twice or more per one object.

Furthermore, after opening portion (106a) is formed in solder resist 106 and pad 63 is exposed, laser irradiation is continued to conduct desmearing. More specifically, by irradiating a laser on the surface of pad 63 (copper), resin residue on pad 63 and oxidized film (63b) (copper oxide) on the surface of pad 63 are removed. Accordingly, resin residue on pad 63 is reduced, and a decrease in solderability caused by resin residue is suppressed. Also, because conductor (63a) (surface (F1) of pad 63) is exposed through opening portion (106a), an increase in resistance does not result from oxidized film (63b) when solder (1000a) (FIG. 3) is formed on pad 63. Moreover, since hole boring (removing solder resist 106) and desmearing are conducted by the same laser irradiation process, another desmearing step is not required. In addition, when a roughened surface is formed on conductor (63a) (surface (F1) of pad 63), the surface of pad 63 (copper) is irradiated by a laser to smooth it. Accordingly, residual voids are reduced during the subsequent surface treatment of the pad (such as Ni/Au plating) with the expected effect of preventing solder from falling off.

Also, through the above laser irradiation, surface (F1) of pad 63 (surface of conductive layer 116) exposed from solder resist 106 is roughened (see FIG. 5 and FIG. 6). Accordingly, bonding strength is enhanced between surface (F1) of pad 63 and solder (1000a) (FIG. 3).

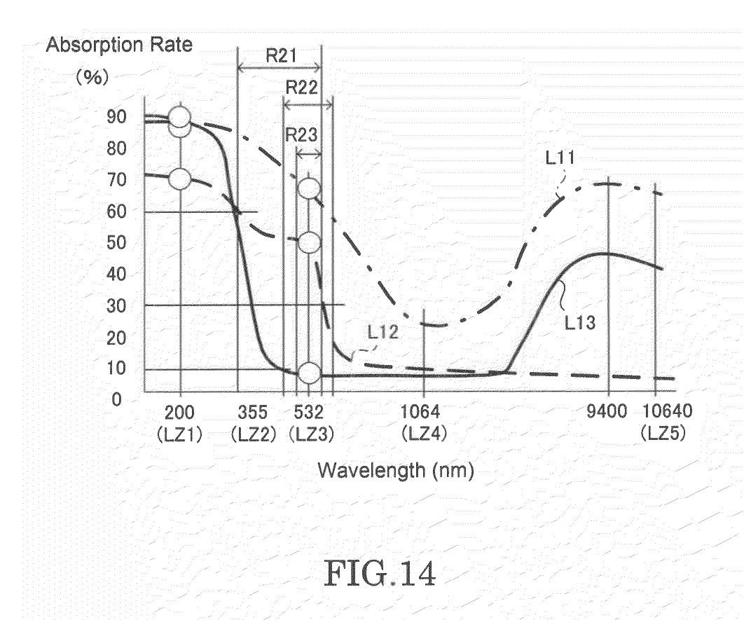

In the present embodiment, by using a green laser when irradiating a laser for the above hole boring and desmearing (step (S13) in FIG. 7), resin residue is removed from pad 63 (conductive pattern) after laser irradiation, and that oxidized film (63b) is removed from the surface of pad 63. Also, by adjusting the amount of filler 62 in an appropriate range, opening portion (106a) is formed in solder resist 106 at a lower laser intensity, namely, by a smaller number of shots (for example, one shot). In the following, the reasons are described with reference to FIG. 14 and others.

FIG. 14 is a graph showing the relationship between a wavelength of laser beam and absorption rates when laser beam is irradiated on epoxy resin (line L11), copper (line L12) and silica (line L13) respectively. If epoxy resin is replaced with other resins (especially thermosetting resins), substantially the same results are obtained.

Laser beam (LZ3) (green laser) with an approximate wavelength of 532 nm is compared with laser beam (LZ5) with an approximate wavelength of 10640 nm. As for laser beam (LZ3), a second harmonic of a YAG or YVO₄ laser may be used, for example. As for the source for laser beam (LZ5), a CO₂ laser, for example, may be used.

As shown in FIG. 14, absorption rates of laser beam (LZ5) are high in both epoxy resin (line L11) and silica (line L13). However, absorption rates of laser beam (LZ3) are high, approximately 50˜70%, in epoxy resin (line L11) and low, approximately less than 10%, in silica (line L13). Filler 62 (silica-type filler) is contained along with resin 61 (epoxy resin) in solder resist 106 in the present embodiment. Thus, when a green laser is irradiated at solder resist 106, filler 62 suppresses a decomposition reaction (photochemical reaction) from progressing in solder resist 106. As a result, when irradiating a laser for hole boring in solder resist 106 (step (S13) in FIG. 7), excessive removal of pad 63 beneath solder resist 106 is suppressed. Especially, since the absorption rate of laser beam (LZ3) in silica (line L13) is approximately less than 10%, the above effect is considered to be great.

Here, the amount of filler 62 in a method for manufacturing a wiring board according to the present embodiment is in an approximate range of 2˜60 wt. %. From the experiment results conducted by the inventors, if the amount of filler 62 is less than approximately 2 wt. %, there is a concern of damage to the surface of pad 63. On the other hand, if the amount of filler 62 exceeds approximately 60 wt. %, removing solder resist 106 becomes difficult. Therefore, if the amount of filler 62 contained in solder resist 106 is adjusted in an approximate range of 2˜60 wt. %, opening portion (106a) is formed in solder resist 106 by a lower number of shots without damaging the surface of pad 63. Moreover, since the resin ingredient contained in solder resist 106 is selectively removed, filler 62 is concentrated near the interface between solder resist 106 and pad 63. As a result, irradiation energy of the laser beam is suppressed due to filler 62 near the interface, and thus only oxidized film (63b) is removed without excessively removing pad 63.

Also, the average particle diameter of filler 62 (silica-type filler) is preferably in an approximate range of 0.5˜20 μm. If the average particle diameter of filler 62 is smaller than approximately 0.5 μm, there is a concern of damage to the surface of pad 63. On the other hand, if the average particle diameter of filler 62 exceeds approximately 20 μm, removing solder resist 106 becomes difficult. Therefore, if the average particle diameter of filler 62 contained in solder resist 106 is adjusted in an approximate range of 0.5˜20 μm, opening portion (106a) is formed in solder resist 106 by a lower number of shots without damaging the surface of pad 63.

As shown in FIG. 14, the absorption rate in copper (line L12) is higher in laser beam (LZ3) than in laser beam (LZ5). When desmearing after hole boring, the absorption rate of laser beam in copper is preferably higher to a certain degree, since it is easier to remove oxidized film (63b). However, if the absorption rate of laser beam in copper is too high, there is an inconvenience such as excessive removal of copper (conductor (63a)). For that matter, since green laser is appropriately absorbed in copper, a green laser is suitable for desmearing by laser irradiation. The absorption rate of laser beam in copper is preferably approximately 50%.

Also, laser beam having a shorter wavelength than laser beam (LZ4) with an approximate wavelength of 1064 nm decomposes the object primarily through a photochemical reaction; and laser beam having a longer wavelength than that of laser beam (LZ4) decomposes the object primarily through a thermal reaction. If two reactions are compared, energy efficiency becomes higher in a photochemical reaction in which beam is directly used than in a thermal reaction in which beam is used after being converted to heat. Accordingly, green laser is considered to be excellent from the viewpoint of energy efficiency.

Laser beam (LZ1) with an approximate wavelength of 200 nm, laser beam (LZ2) (UV laser) with an approximate wavelength of 355 nm, and laser beam (LZ3) (green laser) with an approximate wavelength of 532 nm are compared. As the source of laser beam (LZ1), an excimer laser may be used, for example. As for laser beam (LZ2), a third harmonic of YAG or YVO₄ laser may be used, for example.

Those laser beams (LZ1)˜(LZ3) are the same in that they decompose the object primarily through a photochemical reaction. However, as shown in FIG. 14, regarding absorption rates in epoxy resin (line L11), copper (line L12) and silica (line L13), laser beam (LZ1) is the highest, laser beam (LZ2) is the second highest, and laser beam (LZ3) is the lowest. More specifically, absorption rates of laser beams (LZ2) and (LZ3) are listed in the order of epoxy resin (line L11), copper (line L12) and silica (line L13) from the highest to the lowest rate. However, the absorption rates of laser beam (LZ1) are listed in the order of epoxy resin (line L11), silica (line L13) and copper (line L12) from the highest to the lowest rate. Moreover, regarding laser beam (LZ1), the absorption rate in epoxy resin (line L11) is hardly any different from the absorption rate in silica (line L13). Therefore, if an excimer laser is used in the above laser irradiation step (step (S13) in FIG. 7), the effects of lowering the laser absorption rate by filler 62 are considered to be low.

As described above, the laser beam to be used for irradiating a laser for hole boring and desmearing (step (S13) in FIG. 7) preferably decomposes the object primarily through a photochemical reaction, namely, to have an approximate wavelength of 1064 nm or shorter. In addition, to increase the absorption rate of laser beam in copper, absorption rates of laser beam preferably are in the order of epoxy resin (line L11), copper (line L12) and silica (line L13) from the highest to the lowest rate. Therefore, the wavelength of the above laser beam preferably is in range (R21) in FIG. 14, namely, in an approximate range of 300˜1064 nm. Furthermore, when considering the effects of lowering laser absorption rates by filler 62, the efficiency of removing solder resist 106 and the like, the wavelength of the above laser beam is preferably in an approximate range of 450˜600 nm (range R22), especially in an approximate range of 500˜560 (range R23).

As for sources, a YAG laser, YVO₄ laser, argon ion laser, and copper vapor laser are preferred. For example, if a YAG laser or YVO₄ laser is used as a source, laser beam with an approximate wavelength of 1064 nm is obtained as a fundamental wave, laser beam with an approximate wavelength of 532 nm is obtained as a second harmonic, and laser beam with an approximate wavelength of 355 nm is obtained as a third harmonic. Alternatively, if an argon ion laser is used, laser beam having a wavelength in an approximate range of 488˜515 nm is obtained. Yet alternatively, if a copper vapor laser is used, laser beam having a wavelength in an approximate range of 511˜578 nm is obtained. However, sources are not limited to such, and it is preferred to select an appropriate source according to the required laser wavelength. Also, the fundamental wave of each source may be used, or a harmonic of each source may also be used.

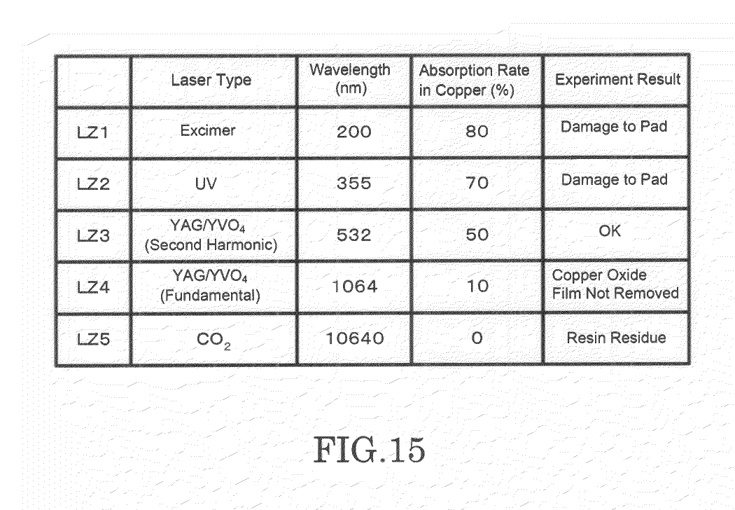

In pad 63 (copper), the absorption rate of laser beam used above for irradiation when boring holes and desmearing (step (S13) in FIG. 7) is preferably in an approximate range of 30˜60%. In the following, the reasons will be described with reference to FIG. 15.

FIG. 15 is a table showing the results of the above-described hole boring and desmearing by irradiating solder resist 106 with five laser beams (LZ1)˜(LZ5) each having a different wavelength.

As shown in FIG. 15, if the absorption rate in copper exceeds approximately 60% (for example, laser beams (LZ1, LZ2)), there is a concern of damage to the surface of pad 63. On the other hand, if the absorption rate in copper is approximately less than 30% (for example, laser beams (LZ4, LZ5)), removing solder resist 106 and oxidized film (63b) is considered to be difficult. Thus, if a laser whose absorption rate in pad 63 (copper) is in an approximate range of 30˜60% (for example, laser beam (LZ3)) is used, resin residue on pad 63 (conductive pattern) after laser irradiation is reduced and damage to the surface of pad 63 is suppressed.

After the laser irradiation step (step (S13) in FIG. 7), wiring board 100 (especially the structure shown in FIG. 4) is completed. As described above, during the laser irradiation process, resin residue on pad 63 is removed, while oxidized film (63b) on the surface of pad 63 is also removed. In addition, as a result, the electrical characteristics of pad 63 (external connection terminal) are enhanced in wiring board 100.

So far, a method for manufacturing a wiring board according to the embodiment of the present invention has been described. However, the present invention is not limited to the above embodiment.

Conductor (63a) of pad 63 is not limited to a double-layer structure of electroless plated film and electrolytic plated film. For example, as shown in FIG. 16 (a cross-sectional view corresponding to FIG. 4), for example, conductor (63a) may also be a triple-layer structure of metal foil 2001 (such as copper foil), electroless copper-plated film 2002, for example, and electrolytic copper-plated film 2003, for example, laminated in that order from the side of insulation layer 104. Moreover, the number of layers of conductor (63a) is not limited to two or three layers, and conductor (63a) may also be formed with four or more layers, for example.

In the above embodiment, 50 wt. % or more of filler 62 (silica-type filler) contained in solder resist 106 was ground silica. However, filler 62 is not limited to such and any other silica-type filler may be used as filler 62. For example, as shown in FIG. 17, 50 wt. % or more of filler 62 (silica-type filler) contained in solder resist 106 may be spherical silica.

As the material for pad 63 (especially for conductor (63a)), another conductor may also be used instead of copper. As long as a relationship substantially the same as shown in FIG. 14 is obtained, substantially the same effects as described above are achieved.

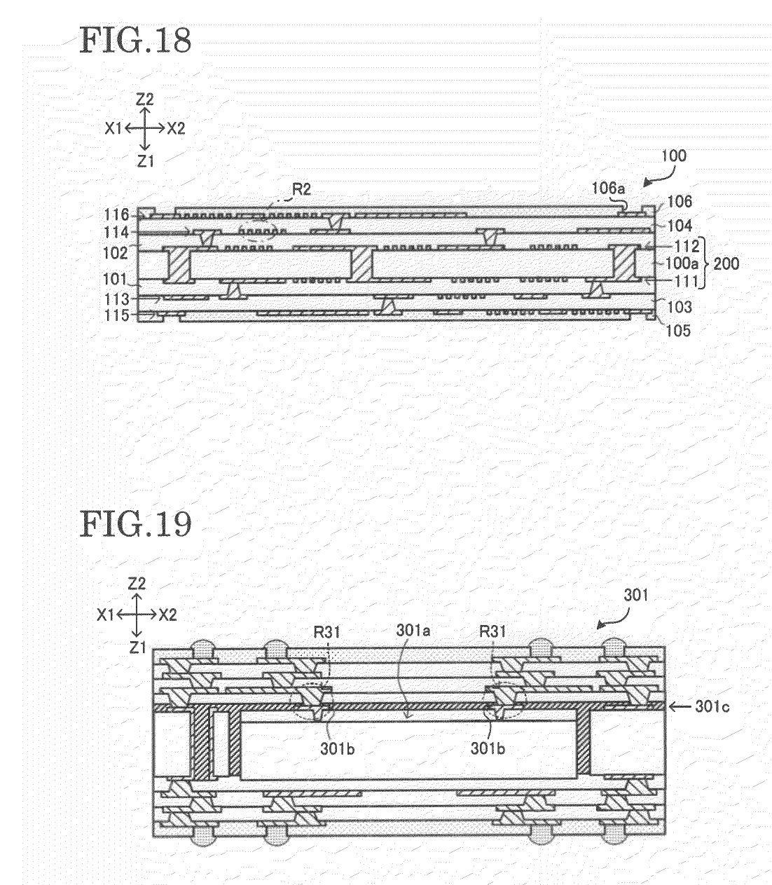

In the above embodiment, an example is described for forming the structure of region (R1) (outer-layer portion) in FIG. 1 using a method shown in FIG. 7 and FIG. 8 through FIG. 12. However, the above method may also be used for forming the structure of region (R2) (inner-layer portion) in FIG. 18. In such a case, insulation layer 102 (interlayer resin insulation layer) instead of insulation layer 104 is the lower insulation layer, and insulation layer 104 (interlayer resin insulation layer) instead of solder resist 106 is the upper insulation layer. In such an example, insulation layer 104 is preferred to be made by adding approximately 2˜60 wt. % filler to resin, the same material as for solder resist 106 shown in the above embodiment.

In the above embodiment, in step (S13) in FIG. 7, laser beam was irradiated to expose pad 63 so that it would work as an external connection terminal. However, the above method is not limited to being used for pad 63, and may also be used to expose other conductive patterns (such as pads of an electronic component or other wiring board built into the wiring board). Also, instead of holes to position external connection terminals (such as solder bumps), opening portions for via holes, through holes or the like in inner layers may be formed by the above laser irradiation. Moreover, opening portions other than holes (such as grooves or notches) may also be formed by the above laser irradiation.

For example, as shown in FIG. 19, when wiring board 301 with built-in electronic component (301a) is manufactured by the above method, electrode (301b) (conductive pattern in conductive layer (301c)) of electronic component (301a) may be exposed by the above laser irradiation. In doing so, via connection portion (R31) may be formed between electrode (301b) of electronic component (301a) and its upper conductive layer.

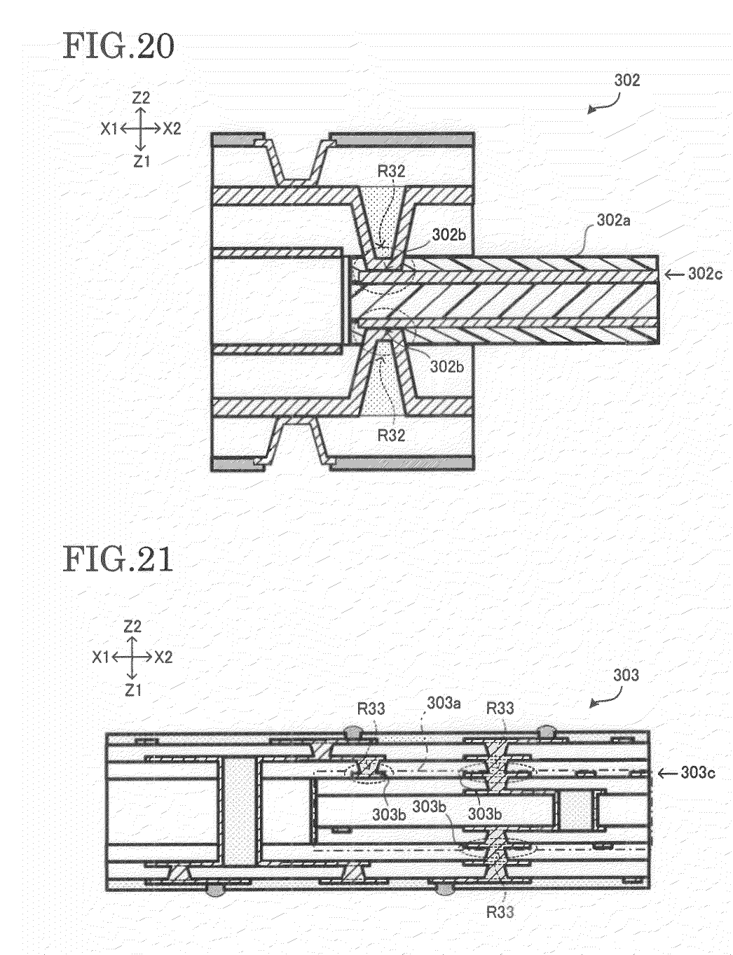

For example, as shown in FIG. 20, when flex-rigid wiring board 302 is manufactured by the above method, pad (302b) (conductive pattern in conductive layer (302c)) of flexible wiring board (302a) may be exposed by the above laser irradiation. In doing so, via connection portion (R32) may be formed between pad (302b) of flexible wiring board (302a) and rigid section (upper conductive layer).

For example, as shown in FIG. 21, when wiring board 303 with another built-in wiring board (303a) (such as a highly integrated wiring board) is manufactured by the above method, pad (303b) (conductive pattern in conductive layer (303c)) of the other wiring board (303a) may be exposed by the above laser irradiation. In doing so, via connection portion (R33) may be formed between pad (303b) of other wiring board (303a) and its upper conductive layer.

Regarding other features, the structure of wiring board 100 and its elements such as the type, properties, measurements, quality, configuration, number of layers and positioning may be freely modified within a scope that does not deviate from the gist of the present invention. For example, via connection portions (R31˜R33) may be conformal conductors or filled conductors.

The method for manufacturing wiring board 100 is not limited to the contents shown in FIG. 7, and the order and contents may be freely modified within a scope that does not deviate from the gist of the present invention. Also, some steps may be omitted according to usage requirement or the like.

The above embodiment and each modified example may be combined freely. It is preferred to select an appropriate combination according to usage requirements or the like.

Obviously, numerous modifications and variations of the present invention are possible in light of the above teachings. It is therefore to be understood that within the scope of the appended claims, the invention may be practiced otherwise than as specifically described herein.

What is claimed is:

1. A method for manufacturing a wiring board, comprising:
forming a conductive pattern on an insulation layer;
forming on the conductive pattern a resin insulation layer comprising a resin and a silica-type filler, the silica-type filler in the resin insulation layer being in an amount of approximately 2˜60 wt. %; and
irradiating a laser beam having an absorption rate with respect to the conductive pattern is in an approximate range of 30˜60% such that an opening portion reaching the conductive pattern is formed through the resin insulation layer.

2. The method for manufacturing a wiring board according to claim 1, wherein the conductive pattern is made of copper, and the laser beam has a wavelength in an approximate range of 450˜600 nm.

3. The method for manufacturing a wiring board according to claim 2, wherein the laser beam has a wavelength in an approximate range of 500˜560 nm.

4. The method for manufacturing a wiring board according to claim 1, wherein the conductive pattern is made of copper, and the source of the laser beam is one of a YAG laser, a YVO₄ laser, an argon ion laser and a copper vapor laser.

5. The method for manufacturing a wiring board according to claim 1, wherein the conductive pattern is made of copper, and the laser beam is a second harmonic generation of one of a YAG laser and a YVO₄ laser.

6. The method for manufacturing a wiring board according to claim 1, wherein the irradiating of the laser beam comprises scanning one shot of the laser beam per one irradiation spot for the opening portion.

7. The method for manufacturing a wiring board according to claim 1, further comprising forming a shading mask having an opening portion over the resin insulation layer, wherein the irradiating of the laser beam comprises scanning the laser beam over an entire surface of the resin insulation layer through the shading mask.

8. The method for manufacturing a wiring board according to claim 1, wherein the irradiating of the laser beam comprises removing an oxidized film formed on an surface of the conductive pattern.

9. The method for manufacturing a wiring board according to claim 1, wherein the irradiating of the laser beam comprises roughening a surface of the conductive pattern.

10. The method for manufacturing a wiring board according to claim 1, wherein the absorption rate of the laser beam with respect to the silica-type filler is approximately less than 10%.

11. The method for manufacturing a wiring board according to claim 1, wherein the silica-type filler has an average particle diameter in an approximate range of 0.5˜20 μm.

12. The method for manufacturing a wiring board according to claim 1, wherein the silica-type filler comprises at least one filler selected from the group consisting of silica, a metal compound having a surface treated with silica, and talc.

13. The method for manufacturing a wiring board according to claim 1, wherein the silica-type filler comprises an amorphous ground silica.

14. The method for manufacturing a wiring board according to claim 1, wherein the forming of the resin insulation layer comprises semi-curing the resin insulation layer, and the irradiating of the laser comprises irradiating the laser beam upon the resin insulation layer in a semi-cured state.
